(19) United States
(12) Patent Application Publication
(10) Pub. No.: US 2014/0183151 A1
(43) Pub. Date: Jul. 3, 2014

(54) MOBILE WORKING MACHINE

(71) Applicant: Terex Cranes Germany GmbH, Zweibrucken (DE)

(72) Inventor: Alfons Weckbecker, Zweibrucken (DE)

(73) Assignee: Terex Cranes Germany GmbH, Zweibrucken (DE)

(21) Appl. No.: 14/146,400

(22) Filed: Jan. 2, 2014

(30) Foreign Application Priority Data
Jan. 3, 2013 (DE) DE102013000463.2

(51) Int. Cl. B66C 23/80; B66C 13/18

(52) U.S. Cl. CPC B66C 23/80; B66C 13/18
USPC 212/276; 212/304

(57) ABSTRACT

A mobile working machine, especially a mobile crane, having an undercarriage (1) and a support device with support cylinders (2) to create the support base required for operation, a top carriage (3) mounted pivotably on the undercarriage (1), as well as an apparatus compatible with the type of the working machine, in particular outriggers (4) and a counterweight arrangement (5). One or more additional hydraulic supports (6) are arranged on the undercarriage (1) underneath or in the proximity of the pivot bearing of the top carriage (3), as well as a control unit (7, 8, 9), which monitors the loads of the support device (2) and controls and monitors the additional supports (6).

### CROSS REFERENCE TO RELATED APPLICATION

This application claims the benefit of German Application DE 102013000463.2, filed Jan. 3, 2013, the contents of which are incorporated herein by reference thereto.

### FIELD OF INVENTION

The invention relates to a mobile working machine, especially a mobile crane, having an undercarriage and a support device with support cylinders to create the support base required for operation, a top carriage mounted pivotably on the undercarriage, as well as an apparatus which determines the type of the working machine, in particular outriggers and a counterweight arrangement.

### BACKGROUND

The increasing demands on performance, weights to be transported and in part limitations to the supporting forces represent challenges for the development of mobile working machines.

Monitoring the standard support devices is state-of-the-art. Apart from monitoring the variable geometry of the support base, the loads of the supports are also recorded and monitored in DE 102008021627A1. DE10110176A1, by way of example, discloses a measuring principle to monitor the supporting forces. DE102007055535A1 discloses monitoring and control of the support device for automatic leveling and a uniform load state when setting up a mobile crane.

No devices or methods have, however, been known which disclose an automatic refraction of the support device with load, because in usual support devices the load of the individual supports results from the load state of the working machine and the rigidity of the structure. A readjustment therefore does not significantly influence the maximum supporting forces that can be achieved in the load case—that is, the operating mode of the working machine.

In order to reduce the extreme supporting forces occurring with high loads and load torques, additional supports had already been arranged in the past in order to relieve the standard support device in the loaded state of the machine.

These so-called central supports have been used as purely mechanical systems, wherein the supporting structure of the undercarriage or of the support beam is directly fitted underneath or only taken over by a defined gap above a certain degree of deformation of the undercarriage, generating statically undetermined conditions in each case.

The disadvantage of a direct substructure is that the force to be absorbed can be very high, so that the central supports have to be designed as very massive, and the complexity for the load distribution on the undercarriage and ground will be correspondingly high. In order to reduce the force on the central support, the configuration of the central support with a gap to be specified can be selected, so that the support itself is only loaded after a certain deformation of the undercarriage. For this purpose a complex calculation of the deformation has to be carried out to determine the size of the gap. A predefined gap is then set up on the central support, influencing in this way the distribution of the loads on the standard supports and central support, and the maximum values are kept within limits.

All these methods have, however, shown that the central support has to absorb very high loads, in particular when the crane is subjected to heavy loads in steep positions because the shearing force share is high in this case, and the torque share quite low, or else because the relief of the standard support does not occur as desired. Another disadvantage is that these mechanical solutions can only be adjusted to one load case and, as a rule, an automatic updating to different load cases is not possible on the basis of a given state of the crane.

It is extremely difficult to take into account the influence of the ground resilience and its effects on the statically undetermined system mentioned above.

Non-regulated active hydraulic systems with a predefined, constant supporting force through supply (pressure supply) fail in that, in areas of crucial stability, the machine is at risk of tipping by the active supply. This relates to the stability in the direction of the load, but also the risk of tipping backward (crane without load).

### SUMMARY OF THE INVENTION

The object of the invention is to limit the maximum supporting forces of the standard support in order to reduce the complexity of the structure or to increase the performance of the working machine in case of a given maximum load on the supports without reinforcing the standard support.

This object is attained with a mobile crane having one or more additional hydraulic supports on the undercarriage of the working machine underneath or in the proximity of the pivot bearing of the top carriage and a control unit which makes monitoring the loads of the standard support device and controlling the additional hydraulic support(s) possible, and in this way preventing an overload of the standard support device and always ensuring the stability of the working machine at the same time.

As the additional support should basically absorb the distributed loads via the pivot bearing, the arrangement of additional hydraulic supports symmetrically to the pivot bearing, that is to say, to the central axis of rotation, is an advantage.

In this way, according to an embodiment of the invention, an additional hydraulic support can be arranged centrally underneath the pivot bearing.

Another embodiment provides for two additional support cylinders to be arranged on the undercarriage in the region of the outer circle beneath the pivot bearing, so that the load can be distributed in the lateral bars of the usual steel structure and the required support disks be pushed underneath in an easily accessible manner from the outside.

A possible further embodiment provides that four additional support cylinders are provided, which are each arranged at the pivot points of the support outriggers on the undercarriage. As a result of this, the loads per cylinder and therefore the local load on the crane and the distribution on the substrate are more uniform.

In the event that the support outriggers are dismounted to improve the transport properties of the undercarriage, it is furthermore reasonable to integrate the additional support cylinders into the support outriggers in the proximity of the pivot point.

By monitoring the load of the standard supports as well as by means of information about the load state of the working machine and a control, according to the present invention, of the effect of the additional support(s), an effective and safe operation can be ensured. In the case of mobile cranes, the information about the load state is available via the crane's control unit and the prescribed load torque limits. Large mobile cranes with high supporting forces are provided with supporting-force recording as standard equipment due to the high loads on the substrate.

The utilization of the controlled additional supports can thus be increased, if the control of the supporting force is varied for different crane configurations and loads in order to, for example, keep the supporting forces as low as possible and optimize them for a building site.

The advantages of the invention are therefore:
a reduction in loads and ground pressures on the standard supports,
weight savings on the crane in the form of structure and supports,
simple and lighter dimensions of the central support,
a reduction in risks due to unsteady ground conditions.
a reduction in calculation efforts to predetermine a mechanical support,
a reduction in expenditure on the building site compared to the mechanical solution,
a variable control of the different crane configurations and load capacity ranges.

### BRIEF DESCRIPTION OF THE DRAWINGS

Other features, advantages and details, appear by way of example only, in the following detailed description of the embodiments, the detailed description referring to the drawings in which:

FIG. 1 is a side and bottom view of an exemplary mobile working machine;

FIG. 2 is a side and bottom view of another exemplary mobile working machine;

FIG. 3 is a side and bottom view of yet another exemplary mobile working crane;

FIG. 4 is a schematic view of an exemplary control unit that may be used with any of the mobile working machines shown in FIGS. 1-3; and

FIG. 5 is a flow diagram of an exemplary control operation of any of the mobile working machines shown in FIGS. 1-3.

### DETAILED DESCRIPTION

The following description is merely exemplary in nature and is not intended to limit the present disclosure, its application or uses. It should be understood that throughout the drawings, corresponding reference numerals indicate like or corresponding parts and features.

The invention will hereinafter be described with reference to the drawings, wherein they schematically show mobile cranes with the different embodiments of the additional support cylinders, as well as a flow diagram showing the procedural steps.

A mobile crane with support is shown in each case, consisting of an undercarriage 1 with hinged and extensible support beams 2 having support cylinders 11, a top carriage 3 mounted pivotably thereon, an outrigger 4 and a counterweight arrangement 5.

When in operation, the crane is placed on the support, which respectively has a support cylinder 11 with a supporting force detector 10.

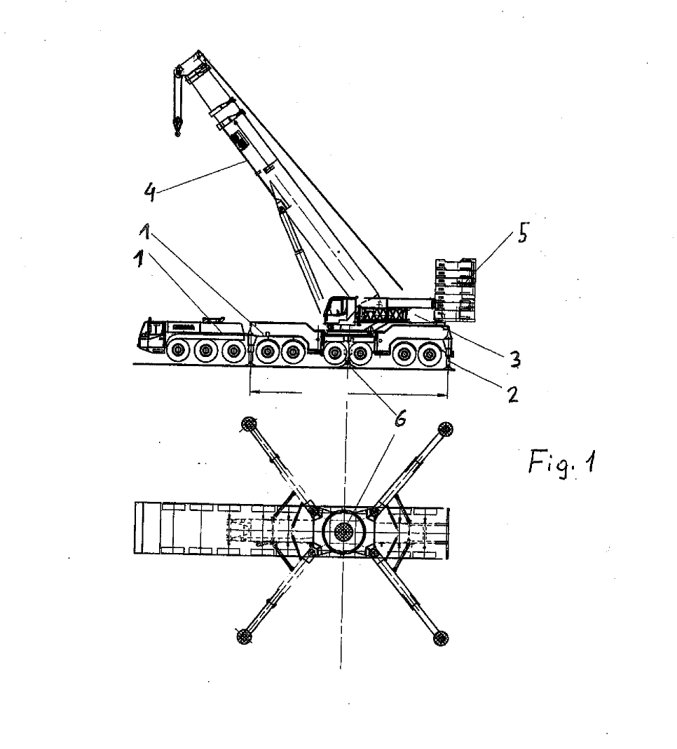

The exemplary embodiment 1 (FIG. 1) provides that another support cylinder 6 with a supporting force detector 10 is centrally arranged underneath the pivot bearing, where said cylinder is hydraulically controlled according to the desired supporting force and thus absorbs the vertical load.

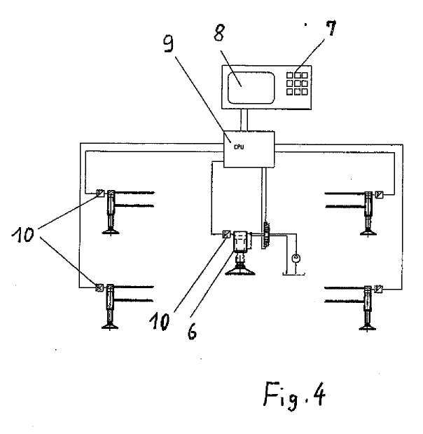

According to the present invention, the operator can, in this case, predetermine the desired setup state and the activation and boundary conditions of the central support or the limitations for the standard supports via a control unit 7, 8 (FIG. 4). This information is transferred to the control unit/CPU 9 of the crane and is used to check and display the desired load capacities or to generate possible new load capacities depending on the limited supporting forces. By confirming the displayed operating conditions, this mode of operation is then activated and the corresponding supporting effect is applied hydraulically to the central support by a hydraulic pump and a switch valve.

While this additional supporting force is applied, but also during a modified load of the crane, the supporting forces of all supports are modified such that recording and monitoring relative to the supporting force specifications are necessary. Depending on the load state and on the supporting force specifications, the additional support is readjusted, which means that the effect of the force is increased or reduced, and a safe operating state of the crane within the specified supporting forces and with adjusted load capacities is possible.

Also provided for is monitoring of the maximum permissible supporting forces as well as the required minimum supporting forces in order to secure the structure against overload and the crane against tipping.

If a readjustment is no longer possible, the method must necessarily retain a safe state and prevent/switch off critical load modifications.

As a rule, the rotation center in the actual execution is not especially reinforced to receive a cylinder, and the support disk would be difficult to access, so that several hydraulically coupled support cylinders could be attached outside.

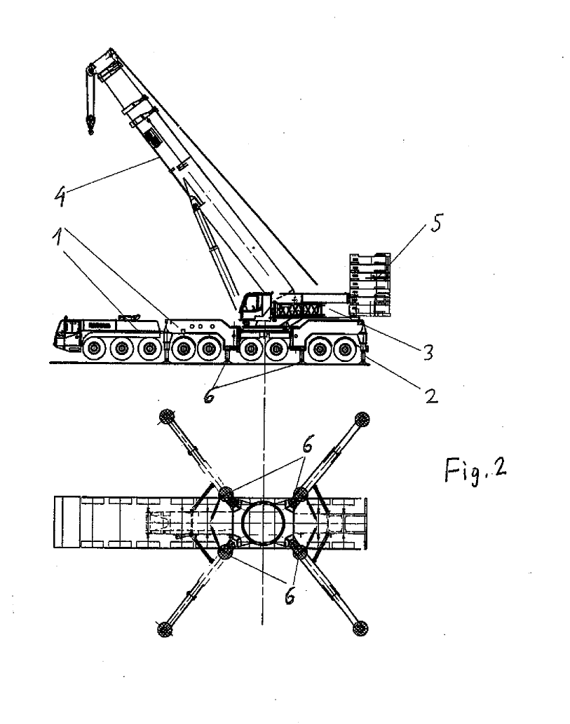

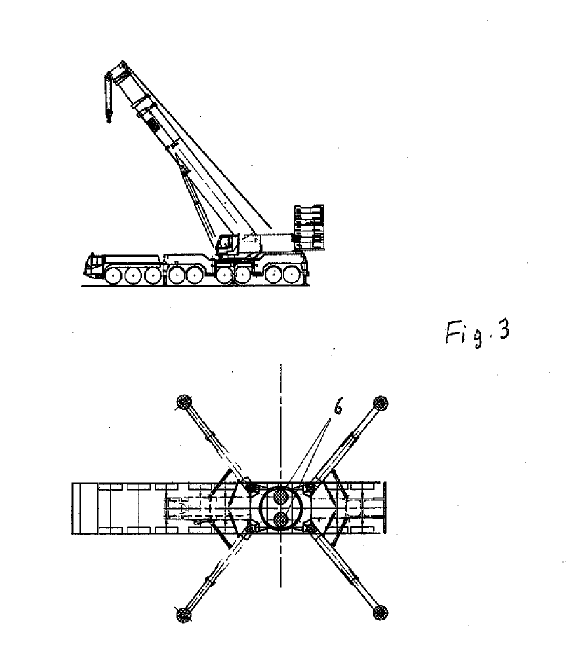

The exemplary embodiment 2 (FIG. 2) and the exemplary embodiment 3 (FIG. 3) therefore show an arrangement of several additional support cylinders on the chassis or on the support beams which are interconnected in their effect and thus have an equivalent central effect. The advantage of this embodiment is that these cylinders are attached to the undercarriage in the region of the pivot bearing such that the load distribution in the structure is simple, and such that access in order to fit the support disks underneath is easily possible. The arrangement of the cylinders in the support beams is a further advantage to reduce the weight of the device in the transport state, if the support beams can be dismounted.

The force effect of the central support(s) is then usefully controlled such that a best possible use of all structural parts and a safe operation of the device are enabled. For this purpose, the load states of the machine recorded by the control unit and the supporting forces/pressures measured and calculated at the standard supports (particularly in the case of caterpillars) are used.

The supporting force of the additional supports is therefore actively adjusted by a suitable control unit such that:
the load capacity of the machine is ensured and, for example, the structure of the undercarriage is not overloaded,
in particular, that a permissible or maximum supporting force at one of the other supports is not exceeded,
that a permissible or maximum supporting force at the additional support is not exceeded,
that the machine is not compromised in its stability by the additional supporting forces.
for use on building sites with limitations on the permissible ground pressures, the load capacities can furthermore be determined/optimized by means of the additional supports.

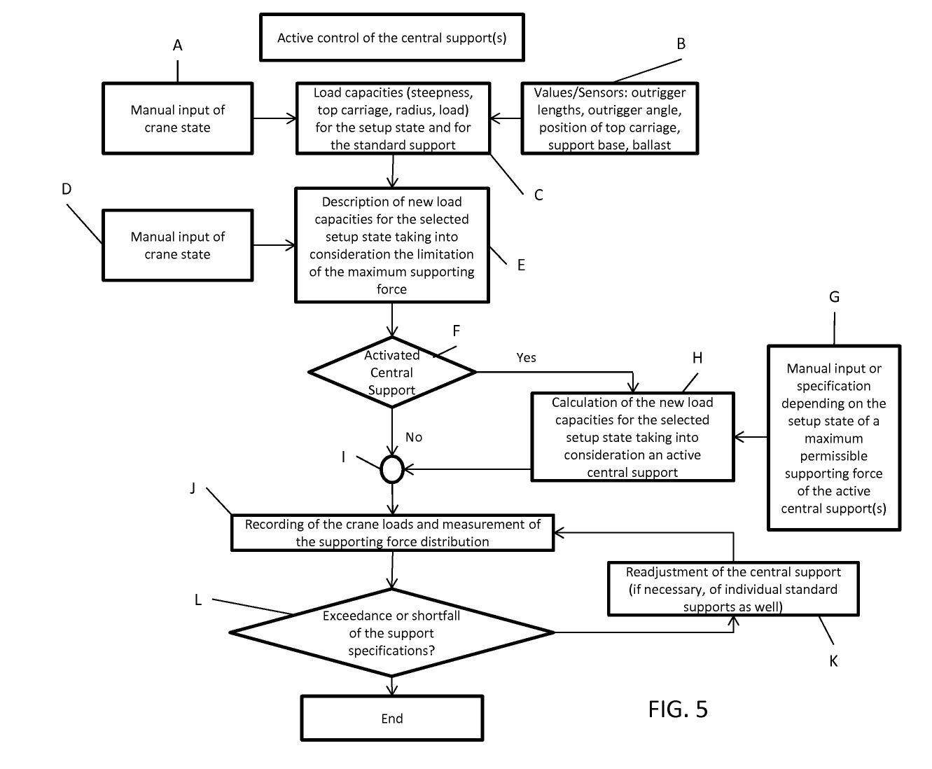

In the case of a mobile crane, it can be assumed that in the state of the art, a manual, or an in part automated specification of the setup state of the crane is given via an input unit and diverse sensors for support base, supporting force distribution, level, outrigger lengths, outrigger positions, ballast, etc. A limitation on the permissible supporting forces permitted for use can be utilized for limited operating states or for switching off critical movements or calculating new load-capacity tables (Items A-E in the flow diagram, FIG. 5).

For an active control of the additional support(s) it is provided according to the present invention that the operator activates the operation of the mobile crane at the input unit with the additional support (Item F in the procedure) and correspondingly enters specification for the permissible support effect (G).

The control unit can calculate new load capacity tables (H) on the basis of these boundary conditions and provide them to the driver (I). By confirming these new operating conditions, this mode of operation is activated with the controlled support, and the corresponding supporting force is applied (J+K).

While this additional supporting force is applied, but also during a modified load of the crane, the supporting forces of all supports are modified, so that recording (L) and monitoring relative to the supporting-force specifications are necessary. Depending on the load state and on the supporting force specifications, the additional support is readjusted, which means that the effect of the force is increased or reduced, and a safe operating state of the crane within the specified supporting forces and with adjusted load capacities is possible.

If a readjustment is no longer possible, the method must necessarily retain a safe state and prevent/switch off critical load modifications.

While the invention has been described with reference to exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed, but that the invention will include all embodiments falling within the scope of the application.

1. A mobile working machine having an undercarriage (1) and a support device with support cylinders (2) to create the support base required for operation, a top carriage (3) mounted pivotably on the undercarriage (1), as well as an apparatus compatible with the type of the working machine, in particular outriggers (4) and a counterweight arrangement (5), wherein one or more additional hydraulic supports (6) are arranged on the undercarriage (1) underneath or in the proximity of several additional hydraulic supports (6), as well as a control unit (7, 8, 9), which monitors the loads of the support device (2) and controls and monitors the additional supports (6).

2. The mobile working machine according to claim 1, wherein the supporting force sensors (10) are assigned to the support cylinders.

3. The mobile working machine according to claim 1, wherein an additional support cylinder (6) is arranged on the undercarriage underneath the pivot bearing.

4. The mobile working machine according to claim 1, wherein two additional support cylinders (6) are arranged on the undercarriage (1) in the region of the outer circle of the pivot bearing.

5. The mobile working machine according to claim 1, wherein four additional support cylinders (6) are provided, which are each arranged on the undercarriage (1) in the proximity of the pivot points of the extensible support outriggers (2).

6. A mobile working machine according to claim 1, wherein the additional support cylinders (6) are arranged on the undercarriage so that they can be dismounted.

7. A mobile working machine according to claim 1, wherein characterized in that the additional support cylinders (6) are integrated into the support outriggers.

8. A method for controlling supporting forces on an additional support of a mobile working machine, the method comprising:
preselecting a desired operating state via a crane operating and control unit;
determining loads of a standard and an additional support by corresponding sensors; and
controlling and monitoring the effect of an additional support via a control unit.

9. The method according to claim 8, wherein the operating conditions of the working machine are recalculated and in particular extended, taking into consideration the effect of the controlled additional support.

10. A method according to claim 9, wherein the effect of the additional support or of the standard support can be limited.

11. A method according to claim 10, wherein the recalculated operating conditions are displayed to the operator.

12. A mobile working machine according to claim 1, wherein the mobile working machine is a mobile crane.
